(19) United States
(12) Patent Application Publication
(10) Pub. No.: US 2010/0130132 A1
(43) Pub. Date: May 27, 2010

(54) SHORT-RANGE COMMUNICATION DEVICE AND MOBILE TERMINAL, AND CONTROL SYSTEM AND METHOD FOR THE SAME

(75) Inventors: Myeong Lo LEE, Seoul (KR); Jung Yeob Oh, Seongnam-si (KR); Seung Woo Shin, Seoul (KR); Jin Yong Kim, Seoul (KR); Kyung Hwa Kim, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/625,989

(22) Filed: Nov. 25, 2009

(30) Foreign Application Priority Data
Nov. 26, 2008 (KR) 10-2008-0118087

(51) Int. Cl. H04B 7/00

(52) U.S. Cl. 455/41.3

(57) ABSTRACT

A short-range communication device and mobile terminal, and a control method and system for the same are disclosed. The control method enables the user to control the mobile terminal through the short-range communication device having motion sensing capability. Hence, the user can conveniently control the operation of the mobile terminal through the short-range communication device.

### CROSS REFERENCE TO RELATED APPLICATION

This application claims priority from and the benefit of Korean Patent Application No. 10-2008-0118087, filed on Nov. 26, 2008, which is hereby incorporated by reference for all purposes as if fully set forth herein.

### BACKGROUND OF THE INVENTION

1. Field of the Invention

Exemplary embodiments of the present invention relate to a short-range communication device and a mobile terminal wherein the short-range communication device is used to operate the mobile terminal for easy use thereof, and to a control system and method for the same.

2. Description of the Background

A mobile terminal is commonly used and may have various functions related to, for example, audio file playback through a MP3 player, image capture through a digital camera module, and mobile gaming or arcade gaming.

To generate input signals for control, a mobile terminal may employ a touch screen based-scheme to produce touch events or a keypad-based scheme to produce key inputs. These schemes may enable the user to readily control operation of the mobile terminal in various ways. However, these schemes require precise touch and click actions. For example, if a mobile terminal user has difficulty in precisely pressing a specific key of the keypad or in precisely touching a specific zone of the touch screen, the user may not be able to generate a desired input signal. This problem tends to become worse with miniaturization of mobile terminals.

Some mobile terminals may communicate with a headset or earpiece through short-range communication. For example, the mobile terminal may receive a user command from the headset or earpiece through infrared or Bluetooth® communication. A short-range communication device may be equipped with buttons for call, play, and power on and off, and may control the operation of the mobile terminal in response to the pressing of a particular button by the user. However, because such a short-range communication device is typically used while being worn over the ear, it may be not easy for the user to recognize the exact position of a desired button, making it difficult to wirelessly control or operate the mobile terminal. To control the operation of the mobile terminal, the user may have to take off the short-range communication device, press a button of the device, and put the device on again.

### SUMMARY OF THE INVENTION

Exemplary embodiments of the present invention provide a mobile terminal and a control method for the same that enables a user to conveniently control the mobile terminal through a short-range communication device.

Additional features of the invention will be set forth in the description which follows, and in part will be apparent from the description, or may be learned by practice of the invention.

Exemplary embodiments of the present invention disclose an apparatus including a mobile terminal and a communication device. The mobile terminal includes an input unit, a first communication unit, a storage unit, and a first control unit. The input unit is configured to generate an input signal. The first communication unit receives a motion signal from the communication device. The storage unit stores at least one application program configured to execute a first function in response to the input signal. The first control unit executes a second function according to the motion signal.

Exemplary embodiments of the present invention disclose a headset including a sensor unit, a control unit, a communication unit, a microphone, and a speaker. The sensor unit generates a sensing signal corresponding to a movement of the headset. The control unit analyzes the sensing signal and generates a motion signal corresponding to the sensing signal. The communication unit transmits the motion signal to a mobile terminal. The microphone receives an audio signal, and the speaker outputs an audio signal from the mobile terminal.

Exemplary embodiments of the present invention disclose a mobile terminal control system including a communication device and a mobile terminal. The communication device is configured to generate a motion signal corresponding to a movement of the communication device. The mobile terminal is configured to execute a first function, and to is execute a second function associated with the motion signal and the first function.

Exemplary embodiments of the present invention disclose a method including forming a communication channel between a mobile terminal and a communication device, and executing a first function of the mobile terminal. The method includes activating a sensor unit of the communication device, generating a motion signal corresponding to movement of the communication device, and executing a second function associated with the motion signal and the first function.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a mobile terminal and a short-range communication device according to exemplary embodiments of the present invention.

FIG. 2 illustrates sensing of movement by an acceleration sensor according to exemplary embodiments of the present invention.

FIG. 3 illustrates sensing of rotational motion by an acceleration sensor according to exemplary embodiments of the present invention.

FIG. 4 is a flow chart illustrating a control method for a mobile terminal is according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Exemplary embodiments of the present invention may be described herein by the use of Bluetooth® communication as an example of short-range communication. However, any suitable communication mechanism may be used for short-range communications. Exemplary embodiments are not limited to Bluetooth® communications.

Hereinafter, exemplary embodiments of the present invention are described in detail with reference to the accompanying drawings.

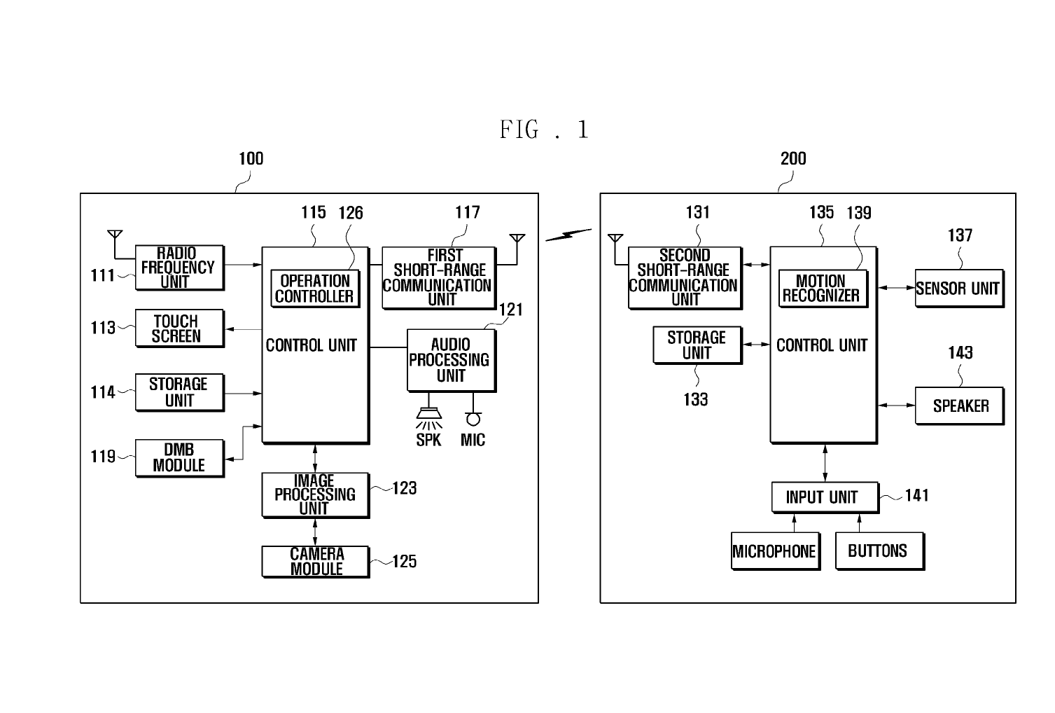

FIG. 1 is a block diagram illustrating a mobile terminal 100 and a short-range communication device 200 according to exemplary embodiments of the present invention.

Referring to FIG. 1, the mobile terminal 100 may include a radio frequency unit 111, a touch screen 113 including a display section and a touch section, a storage unit 114, a control unit 115 including an operation controller 126, a first short-range communication unit 117, a Digital Multimedia Broadcasting (DMB) module 119, an audio processing unit 121, an image processing unit 123, and a camera module 125. The short-range communication device 200 may include a second short-range communication unit 131, a storage unit 133, a control unit 135 including a motion recognizer 139, a sensor unit 137, a speaker 143, and an input unit 141 including a microphone and buttons. Examples of a short-range communication device 200 include, for example, a headset or an earpiece.

A mobile terminal user may execute an application program related to a function selected by the user. When the mobile terminal 100 executes the application program, an operation of the mobile terminal 100 may be controlled according to the motion of the short-range communication device 200 sensed by the sensor unit 137.

Hereinafter, a configuration of the short-range communication device 200 is described.

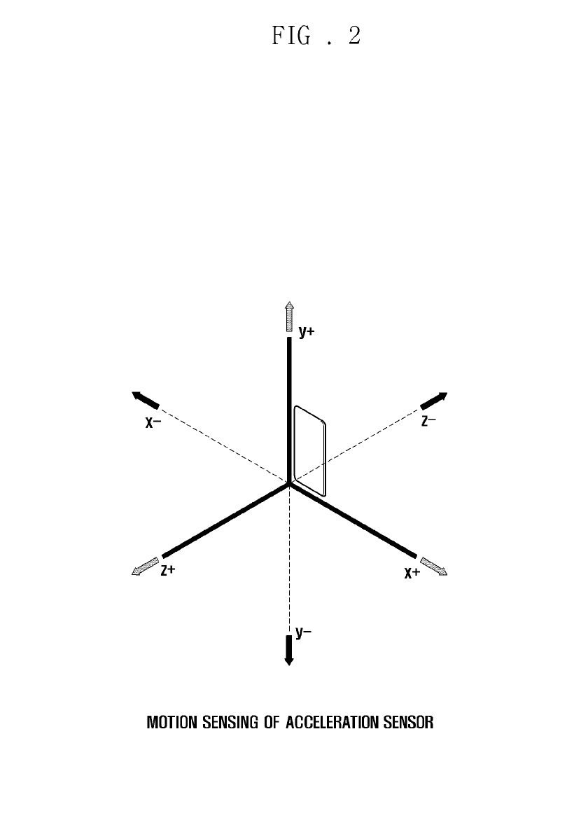

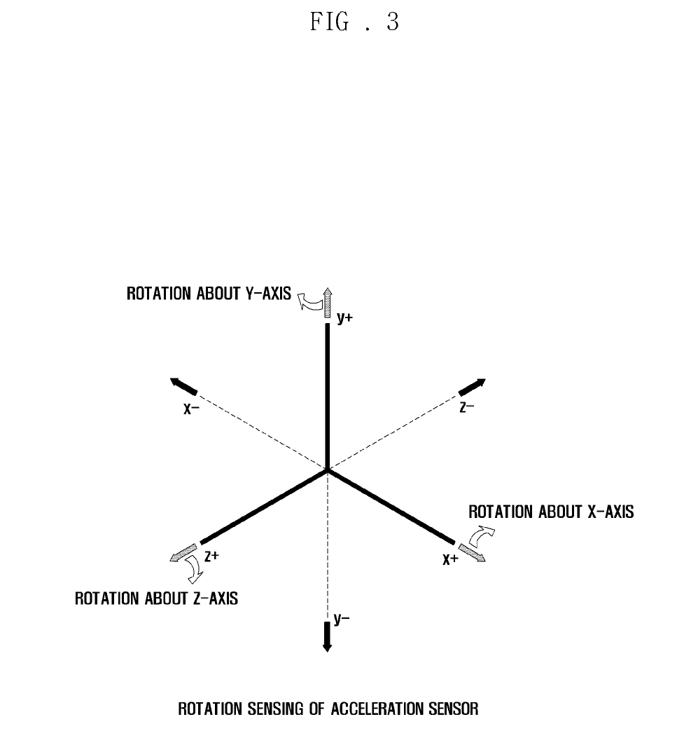

The sensor unit 137 may include an acceleration sensor, a proximity sensor, and/or a microphone to sense movement of the short-range communication device 200. The sensor unit 137 may sense forces applied to the short-range communication device 200, sounds, and may acquire proximity information. Sensed data may be sent to the control unit 135. As shown in FIG. 2, the acceleration sensor may detect movement of the short-range communication device 200 in multiple directions. For example, the acceleration sensor may detect movement towards the up, down, left, right, front, and rear directions. As shown in FIG. 3, the acceleration sensor may also detect rotational movement, for example, in a clockwise and/or counter clockwise direction relative to the x, y, and z axes. A proximity sensor may determine whether the user's body is within a sensing range. The sensor unit 137 may also, in general, include any sensor that can detect the movement of the short-range communication device 200.

The control unit 135 may control the overall operation of the short-range is communication device 200. The control unit 135 may include a motion recognizer 139 to receive a sensing signal from the sensor unit 137, to determine a motion of the short-range communication device 200, and to send the short-range communication device motion signal to the mobile terminal 100 through the second short-range communication unit 131. For example, the motion recognizer 139 may analyze signals collected by the acceleration sensor, proximity sensor, and microphone of the sensor unit 137, determine the motion of the short-range communication device 200 (e.g., single tap, double tap, triple tap, moving of the user's head downwards and upwards, turning of the user's head from side to side, upward tap, or downward tap), and output a corresponding motion signal. The control unit 135 may activate a motion sensing function after receiving a proximity signal from the proximity sensor. The control unit 135 may control the power supply so that only the proximity sensor or the pressure sensor of the sensor unit 137 is turned on first. After a proximity signal is received from the proximity sensor or pressure sensor, the control unit 135 may turn on (e.g., provide power to) the remaining sensors including the acceleration sensor. When a first signal from the proximity sensor or pressure sensor and a second signal from the acceleration sensor are received simultaneously, the control unit 135 may regard the motion of the short-range communication device 200 as valid.

The second short-range communication unit 131 may provide an interface for data communication with a communication device through various short-range communication schemes such as Bluetooth® or infrared communications. The second short-range communication unit 131 may send and/or receive data to and from the mobile terminal 100 using, for example, Bluetooth® communication.

Next, a configuration of the mobile terminal 100 is described.

The radio frequency unit 111 may send and receive voice signals for calls, and is data for data communication under the control of the control unit 115. The radio frequency unit 111 may include a radio frequency transmitter for upconverting the frequency of a signal to be transmitted and for amplifying the signal to be transmitted. The radio frequency unit 111 may also include a radio frequency receiver for low-noise amplifying a received signal and downconverting the frequency of the received signal. The radio frequency unit 111 may establish a communication channel to another mobile terminal to, for example, send and/or receive a voice signal and video signal through the communication channel. An audio signal received by the radio frequency unit 111 can be transmitted to the second short-range communication unit 131 of the short-range communication device 200, and an audio signal from the short-range communication device 200 can be transmitted through the radio frequency unit 111 to another mobile terminal. For example, a microphone in the short-range communication device 200 can receive an audio signal from a user and the received user audio signal may be transmitted to the mobile terminal 100 through the second short-range communication unit 131. The mobile terminal 100 may further transmit the user audio signal to another mobile terminal. A speaker 143 in the short-range communication device 200 can output an audio signal received from the mobile terminal 200 through the radio frequency unit 111. The radio frequency unit 111 may be activated and deactivated by the control unit 115 according to a signal from the short-range communication device 200. That is, an incoming call can be answered according to a motion signal received from the short-range communication device 200.

The audio processing unit 121 may include a speaker to reproduce audio data related to a call, and a microphone to collect audio data, such as a voice signal related to a call. The audio processing unit 121 may perform various audio control operations including activation and deactivation of the speaker and microphone based on a short-range communication device is motion signal sent from the short-range communication device 200, as described in TABLE 1.

The touch screen 113 may include a display section for output and a touch section for input. The touch screen 113 may include on-screen keys and function keys to receive alphanumeric information from the user and to set various functions, and may assign coordinate values to the keys. When a key is touched, the touch screen 113 may send a corresponding touch event signal to the control unit 115. The function keys may include a direction key, a side key, and a short cut key, which are mapped to specific functions. The touch screen 113 may generate key signals for user settings and for controlling the mobile terminal 100, and may send the generated key signals to the control unit 115. The touch screen 113 may display various key images for manipulation of the mobile terminal 100 on the touch section of the touch screen 113, and may identify a touched key by mapping a touch on the touch section to a key image on the display section. The touch screen 113 may generate a touch event corresponding to a touch event signal for selecting one of files stored in the storage unit 114, a drag signal for moving the selected file, or an editing signal for editing the selected file. The touch screen 113 may send the touch event to the control unit 115. The touch screen 113 may send a coordinate value of a touched location to the control unit 115, and the control unit 115 may identify an image corresponding to the coordinate value and may perform a specific function mapped to the identified image. Key signals may be generated though the touch screen 113 as described above, and may also be generated though a keypad.

The display section of the touch screen 113 may output a screen associated with an activated function. For example, the display section may display a boot screen, idle screen, menu screen, call screen, DMB screen, browser screen, and/or camera preview screen. The display section may include a panel of liquid crystal display (LCD) devices, a LCD controller, is and may be connected to a memory for storing video data. If the panel has a touch screen capability, the display section may also act as an input means. The display section may output a screen associated with a function activated according to a user request. For example, in response to activation of a file playback program, the display section may output a screen associated with the file playback program. The display section may output a screen associated with an application program selected by the user, and display an icon for activation of the short-range communication device 200. For example, in response to activation of the short-range communication device 200, the display section may output a corresponding icon or image. The display section may output text or image information regarding control of a file playback program according to a short-range communication device motion signal from the short-range communication device 200. The display section may not display the text or image information in the sleep state, and may display the text or image information in the activation state.

The storage unit 114 may store application programs for the operation of the mobile terminal 100, a User Interface (UI) application program for touch screen capabilities, and an operation list used for controlling an operation according to a short-range communication device motion signal from the short-range communication device 200. The operation list may include information regarding mappings between operations and short-range communication device motion signals with respect to running application programs. The same short-range communication device motion signals may initiate different operations depending upon the current application. For example, generation of a short-range communication device motion signal indicating ‘tap’ in response to arrival of an incoming call may cause the incoming call to be answered. Generation of a short-range communication device motion signal indicating ‘tap’ during music playback may cause the playback to be paused or resumed.

The control unit 115 may control the power supply to the mobile terminal 100, activation of the mobile terminal components, and signal exchanges between the components. The control unit 115 may include the operation controller 126 to perform various control operations related to functions being executed according to a short-range communication device motion signal from the short-range communication device 200. The control unit 115 may refer to the operation list stored in the storage unit 114 for the control operations related to functions being executed. For example, when a short-range communication device motion signal is received from the short-range communication device 200 during execution of a function, the operation controller 126 may search the operation list stored in the storage unit 114 for the function being executed. If the function being executed is listed in the operation list, the control unit 115 may control the function being executed according to the short-range communication device motion signal.

The first short-range communication unit 117 provides an interface for data communication with another communication device through various short-range communication schemes such as, for example, Bluetooth® or infrared communication. The first short-range communication unit 117 may send and/or receive data to and from the short-range communication device 200 through Bluetooth® communication.

The remaining components not described above, such as the DMB module 119, may operate conventionally, and may be controlled by the control unit 115, in part, according to a short-range communication device motion signal from the short-range communication device 200, on the basis of the operation list illustrated in Table 1.

TABLE 1

| Situation | Headset motion | | Action |
|---|---|---|---|
| Reception of call | Tap or Moving the head downwards | | Answer call |
| | and upwards | | |
| | Double tap or Turning the head from | | Reject call |
| | side to side | | |
| | Triple tap | | Mute/Unmute |
| | Upward tap | | Sound volume up |
| | Downward tap | | Sound volume down |
| Call progress | Tap | Reception of a call | Answer call |
| | | 3 way call | Call transfer |
| | Double tap | | Same as Tap |
| | Triple tap | | Mute/Unmute |
| Yes/no popup | Moving the head downwards and | | Display popup |
| display | upwards | | |
| | Side-to-side tap or Turning the head | | No display of popup |
| | from side to side | | |
| Music playing | Tap | | Play/Pause |
| | Double tap | | |
| | Leftward tap or Turning the head | | Previous song |
| | leftwards | | |
| | Rightward tap or Turning the head | | Next song |
| | rightwards | | |
| | Upward tap or Moving the head | | Sound volume up |
| | upwards | | |
| | Downward tap or Moving the head | | Sound volume down |
| | downwards | | |
| | Triple Tap | | Mute/Unmute |
| DMB viewing | Tap | | Screen capture |
| | Double tap | | Start/Stop recording |
| | Leftward tap or Turning the head | | Previous channel |
| | leftwards | | |
| | Rightward tap or Turning the head | | Next channel |
| | rightwards | | |
| | Upward tap or Moving the head | | Sound volume up |
| | upwards | | |
| | Downward tap or Moving the head | | Sound volume down |
| | downwards | | |
| | Triple Tap | | Mute/Unmute |
| Camera | Tap | Photography | Store immediately after |
| previewing | | | photographing |
| | | Moving image | Store immediately after starting and |
| | | | stopping recording |
| | Double Tap | | Mode switching (photography/ |
| | moving image) | | |
| Web browsing | Tap | | Zoom in |
| | Double Tap | | Full screen display |
| | Leftward tap or Turning the | | Right-to-left panning in enlarged |
| | head leftwards | | state |
| | Rightward tap or Turning the | | Left-to-right panning in enlarged |
| | head rightwards | | state |
| | Upward tap or Moving the head | | Upward panning in enlarged state |
| | upwards | | |
| | Downward tap or Moving the | | Downward panning in enlarged |
| | head downwards | | state |
| Photograph | Tap | | Zoom in |
| viewing | Double Tap | | Full screen display |
| | Before | Leftward tap or Turning the | Previous |
| | enlargement | head leftwards | photograph |
| | | Rightward tap or Turning the | Next photograph |
| | | head rightwards | |
| | Enlarged state | Leftward tap or Turning the | Right-to-left |
| | | head leftwards | panning in enlarged |
| | | | state |
| | | Rightward tap or Turning the | Left-to-right |
| | | head rightwards | panning in enlarged |
| | | | state |
| | | Upward tap or Moving the head | Upward panning in |
| | | upwards | enlarged state |
| | | Downward tap or Moving the | Downward panning |
| | | head downwards | in enlarged state |

Next, a method for operating the mobile terminal 100 is described.

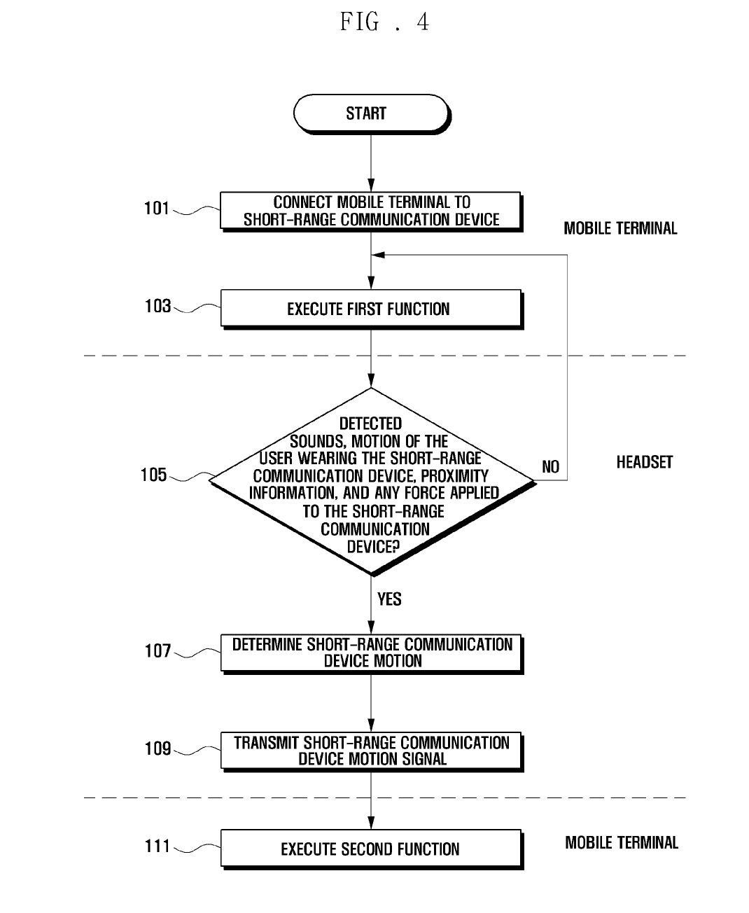

FIG. 4 is a flow chart illustrating a method for operating a mobile terminal 100 according to exemplary embodiments of the present invention.

Referring to FIG. 4, the mobile terminal 100 may connect to the short-range communication device 200 (101). The connection may be established according to the employed specification or technology. For example, if the mobile terminal 100 and the short-range communication device 200 have a Bluetooth® short-range communication module, a short-range communication channel can be established between the mobile terminal 100 and the short-range communication device 200 through Bluetooth® communication. After a communication channel is established, the mobile terminal 100 and the short-range communication device 200 may perform an initialization procedure.

The mobile terminal 100 may execute a first function selected by a user key input through the touch screen 113 (103). The first function may be a function related to call processing, text or image display, DMB reception, camera photographing, photograph viewing, and/or web browsing, as noted in TABLE 1.

The mobile terminal 100 may collect information for executing the first function according to a short-range communication device motion signal received from the short-range communication device 200. For example, the mobile terminal 100 may extract a portion of the operation list stored in the storage unit 114. If the first function is a camera-related function, the mobile terminal 100 may activate the camera module and attempt to control the preview operation of the camera module according to the short-range communication device motion signal. The mobile terminal 100 may then extract a camera-related portion of the operation list, and may deliver the extracted information to the operation controller 126.

The sensor unit 137 of the short-range communication device 200 may detect sounds, motion of the user wearing the short-range communication device 200, proximity information, and any force applied to the short-range communication device 200 (105). To perform step 105, the short-range communication device 200 may supply power to the sensor unit 137. The short-range communication device 200 may supply power to the proximity or pressure sensor, first, and subsequently to the remaining sensors, including, for example, the acceleration sensor, after a proximity signal is generated from the proximity or pressure sensor.

When a sensing signal is received from the sensor unit 137, the control unit 135 of the short-range communication device 200 may determine the motion of the short-range communication device 200 (107). For example, when the user picks up the short-range communication device 200 or touches the short-range communication device 200, the proximity is or pressure sensor of the sensor unit 137 may send a corresponding proximity signal to the control unit 135. The control unit 135 may supply power to the acceleration sensor, which may then be initialized. The acceleration sensor may sense the motion of the user wearing the short-range communication device 200 (e.g., moving the head downwards and upwards or turning the head from side to side), and may send a corresponding sensing signal to the control unit 135. The motion recognizer 139 of the control unit 135 may determine the motion of the short-range communication device 200 based on the sensing signal from the acceleration sensor. When a tap sensor is included in the sensor unit 137, the sensor unit 137 may sense a user tap on the short-range communication device 200 and may send a corresponding sensing signal to the control unit 135, in which the motion recognizer 139 may determine the motion of the short-range communication device 200.

The short-range communication device 200 may transmit a short-range communication device motion signal corresponding to the determined short-range communication device motion to the mobile terminal 100 (109). The control unit 135 of the short-range communication device 200 may generate a short-range communication device motion signal corresponding to the short-range communication device motion determined by the motion recognizer 139, and may send the short-range communication device motion signal though the short-range communication channel to the mobile terminal 100. The mobile terminal 100 may identify the control action on the basis of the stored operation list and the short-range communication device motion signal.

Upon reception of the short-range communication device motion signal from the short-range communication device 200, the mobile terminal 100 may perform a second function by executing an action specified in the operation list and corresponding to the short-range is communication device motion signal (111). The first function may be a user function carried out by a running application program, and the second function may be a user function carried out by applying the short-range communication device motion signal to the first function. For example, the first function may be one of various functions listed in the menu (e.g., photographing, media file playback, phonebook editing, and time measurement), and the second function may be a function executed in response to a key input after the first function is activated (e.g., character input, image capture, and time counting). In addition, the first function may be a function that outputs one or more characters in response to a key input, and the second function may be a function that is executed on the basis of the output characters (e.g., making a call, information search, and memo or schedule writing).

As apparent from the above description, exemplary embodiments of the present invention provide a control method for a mobile terminal wherein the mobile terminal is controlled through a short-range communication device having motion sensing capability. Hence, the user can conveniently control the operation of the mobile terminal through the short-range communication device.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal control system, comprising:
a short-range communication device configured to generate a motion signal corresponding to a movement of the communication device; and
a mobile terminal configured to execute a first function, and to execute a second function associated with the motion signal and the first function.

2. The mobile terminal control system of claim 1, wherein the mobile terminal comprises:
an input unit configured to generate an input signal;
a first short-range communication unit to receive the motion signal from the short-range communication device;
a storage unit to store at least one application program, the at least one application program to execute the first function in response to the input signal; and
a first control unit to execute the second function.

3. The mobile terminal control system of claim 2, wherein the storage unit stores an operation list defining actions corresponding to the motion signal and associated with the second function.

4. The mobile terminal control system of claim 2, wherein the short-range communication device comprises:
a sensor unit configured to generate a sensing signal corresponding to the movement;
a second control unit to analyze the sensing signal and to generate the motion signal, the motion signal corresponding to the sensing signal; and
a second short-range communication unit to transmit the motion signal to the mobile terminal.

5. The mobile terminal control system of claim 4, wherein the short-range communication device further comprises a microphone to receive an audio signal, and a speaker to output an audio signal from the mobile terminal.

6. The mobile terminal control system of claim 4, wherein the short-range communication device comprises a headset or an earpiece.

7. The mobile terminal control system of claim 4, wherein the sensor unit comprises at least one of a proximity sensor, a pressure sensor, an acceleration sensor, a tap sensor, a gyro sensor, and an orientation sensor.

8. The mobile terminal control system of claim 7, wherein the second control unit activates at least one of the acceleration sensor, the tap sensor, the gyro sensor, and the orientation sensor after receiving a sensing signal from the proximity sensor or the pressure sensor.

9. A method, comprising:
forming a communication channel between a mobile terminal and a short-range communication device;
executing a first function of the mobile terminal;
activating a sensor unit of the short-range communication device;
generating a motion signal corresponding to movement of the short-range communication device; and
executing a second function associated with the motion signal and the first function.

10. The method of claim 9, wherein generating a motion signal comprises at least one of:
detecting an object within a determined distance of the short-range communication device;
detecting a touch in response to contact of the short-range communication device with an object;
detecting a tap on the short-range communication device;
detecting a shake in response to the short-range communication device being shaken; and
detecting a rotation of the short-range communication device in one direction.

11. The method of claim 10, wherein generating a motion signal further comprises:
activating at least one of a proximity sensor and a pressure sensor in the sensor unit; and
activating at least one of an acceleration sensor, a tap sensor, a gyro sensor, and an orientation sensor in the sensor unit in response to receiving a sensing signal from the proximity sensor or the pressure sensor.

12. The method of claim 9, further comprising reading from a storage unit, an operation list defining actions corresponding to the motion signal and associated with the second function.

13. A headset, comprising:
a sensor unit to generate a sensing signal corresponding to a movement of a headset;
a control unit to analyze the sensing signal and to generate a motion signal corresponding to the sensing signal;
a short-range communication unit to transmit the motion signal to a mobile terminal;
a microphone to receive an audio signal; and
a speaker to output an audio signal from the mobile terminal.

14. The headset of claim 13, wherein the sensor unit comprises at least one of a proximity sensor, a pressure sensor, an acceleration sensor, a tap sensor, a gyro sensor, and an orientation sensor.

15. The headset of claim 14, wherein the control unit activates at least one of the acceleration sensor, the tap sensor, the gyro sensor, and the orientation sensor in response to receiving a sensing signal from the proximity sensor or the pressure sensor.

16. An apparatus, comprising:
a mobile terminal; and
a short-range communication device,
wherein the mobile terminal comprises:
an input unit configured to generate an input signal;
a first communication unit to receive a motion signal from the short-range communication device;
a storage unit to store at least one application program configured to execute a first function in response to the input signal; and
a first control unit to execute a second function according to the motion signal.

17. The apparatus of claim 16, wherein the storage unit stores an operation list defining actions corresponding to the motion signal and associated with the second function.

18. The apparatus of claim 16, wherein the short-range communication device comprises:
a sensor unit to sense a motion of a user wearing the short-range communication device, to sense a force applied to the short-range communication device, and to generate a sensing signal corresponding to the motion and the force;
a second control unit to analyze the sensing signal and to generate the motion signal, the motion signal corresponding to the sensing signal; and
a second short-range communication unit to transmit the motion signal to the mobile terminal.

19. The apparatus of claim 18, wherein the second control unit analyzes the sensing signal and generates the motion signal in response to receiving a proximity signal indicating that the short-range communication device is within a determined distance of the user.

20. The apparatus of claim 16, wherein the short-range communication device comprises a headset or an earpiece.
